(19) United States
(12) Patent Application Publication
(10) Pub. No.: US 2009/0293258 A1
(43) Pub. Date: Dec. 3, 2009

(54) Anchor insertion rod

(76) Inventor: Robert Cousineau, Ottawa (CA)

Correspondence Address: Robert Cousineau;Station "T", P.O. Box 8341, Ottawa, K1G 3H8, CA

(21) Appl. No.: 12/457,226

(22) Filed: Jun. 4, 2009

(30) Foreign Application Priority Data
Jun. 3, 2008 (CA) 2,633,234
Jun. 20, 2008 (CA) 2,635,491

(51) Int. Cl. B25B 31/00; B25B 27/14

(52) U.S. Cl. 29/522.1; 29/254; 29/277; 81/27

(57) ABSTRACT

An anchor insertion rod is disclosed for use with an anchor insertion tool removable secured therein for the installation and setting of anchors. The anchor insertion rod comprises an outer member and an inner member slidably mounted within the outer member, whereby the inner member can be extended to increase the length of the insertion rod. Upper and lower stop members are positioned on the insertion rod, along with a slide hammer surrounding a portion of the insertion rod that moves along the insertion rod between the upper and lower stop members. To install an anchor, the insertion rod is raised to align an anchor within the anchor insertion tool with a pre-drilled hole in the surface in which the anchor is to be mounted. The slide hammer is moved to forcibly contact the upper stop member to impart an impacting force to insert the anchor. The anchor is set by moving the slide hammer to contact the lower stop member and impart a setting force to the lower stop member. Once the anchor is set, handles on the insertion rod are then rotated to disengage and separate the anchor from threaded engagement with the insertion rod and the anchor insertion tool.

The present invention relates to a device meant to be used for the insertion and setting of anchors, such as wedge and drop-in type anchors.

### BACKGROUND OF THE INVENTION

Anchors are conventionally used in construction to attach various components of a building construction to an overhead ceiling or other structure. Such components to be attached can relate to, for example, services that provide plumbing, electrical, drainage, sprinkler system piping and drop ceilings. From these anchors, which are usually of the wedge or drop-in type variety, all of the above services and ceilings are suspended or secured.

Conventionally, in setting an anchor to suspend a drop ceiling, for example, a hole is pre-drilled in the surface to which the anchor is to be applied, the anchor generally having a slot through which a wire is inserted and twisted to connect the channels of the suspended ceiling to the anchor. Usually, the anchor is threadably inserted into an anchoring head or other anchor placement device, which is then usually mounted onto a manually operated elongated rod, such as that described in Canadian Patent Application No. 2,233,513, whereby a worker standing on a floor below the ceiling can reach up and insert the anchor into the pre-drilled hole without requiring the use of scaffolding or other raising means.

The anchor positioned within the anchoring head or other anchor placement device is then driven upwardly, through use of the manually operated elongated rod, to forcibly insert the anchor in place within the pre-drilled hole.

Then, the elongated rod is pulled sharply downwardly to “set” the anchor in place, at which point the anchor would be disengaged from the anchoring head, and the elongated rod reloaded, to continue on with the placement and setting of additional anchors. Canadian Patent Application No. 2,233,513 discloses connecting a wire loop to the anchor whereby, once the anchor is set within the pre-drilled hole, and a hooked portion (anchoring hook) attached to the anchoring head would then be used to engage the wire loop and, by pulling the elongated rod downwardly, set the anchor. The hook would then be removed from the wire loop to continue on to the next anchor setting.

However, the use of devices such as this requires more time to place the anchors, slowing the installation process, as wire loops are required to be attached to the anchors and then, once the anchor is set, the anchoring head must be disengaged from the anchor, so that the hooked portion attached to the anchoring head can engage the wire loop and set the anchor. Furthermore, such devices are mostly restricted to utilizing one configuration of anchors.

It would therefore be advantageous to have an improved anchor insertion rod for use with an anchor insertion tool securing an anchor therein for installation and setting, and that can be quickly and accurately used to both insert and set the anchor in a pre-drilled hole. It would be further advantageous to have an improved anchor insertion rod that does away with the need to utilize wire loops and an anchoring hook to set the anchor, simplifying the anchor setting process and increasing productivity.

### SUMMARY OF THE INVENTION

The present invention provides an improved anchor insertion rod which can be quickly and accurately used to both insert and set an anchor, and which utilizes handles to selectively release the anchor from engagement with the anchor insertion rod and anchor insertion tool mounted thereon.

The present invention also provides an improved anchor insertion tool having an internally threaded bore defined on the top surface thereof for securing and mounting an anchor therein, and which can be constructed and arranged to accommodate varying sizes of threaded anchors.

According to a first broad aspect of an embodiment of the present invention, there is disclosed a setting tool for use with an anchor insertion tool constructed and arranged to hold an anchor for installation and setting, the setting tool comprising an elongated shaft having an upper shaft end and a lower shaft end and a shaft outer surface, the shaft upper end being constructed and arranged to removably secure the anchor insertion tool by a releasable securing means; an upper stop member positioned on the shaft outer surface; a lower stop member positioned on the shaft outer surface; a slide hammer surrounding at least a portion of the shaft and constructed and arranged to be selectively slidable along the shaft between an impacting position in which it contacts the upper stop member and a setting position in which it contacts the lower stop member; and handle means removably secured to the shaft outer surface and constructed and arranged to selectively release the anchor from the anchor insertion tool.

According to a second broad aspect of an embodiment of the present invention, there is disclosed a setting tool for use with an anchor insertion tool constructed and arranged to hold an anchor for installation and setting, the setting tool comprising an elongated shaft having an upper shaft end, a lower shaft end and a shaft outer surface, and further comprising an outer member and an inner member slidably mounted within the outer member, the shaft upper end being constructed and arranged to removably secure the anchor insertion tool by a releasable securing means, and wherein a cross-sectional width of the outer member is greater than a cross-sectional width of the inner member; an upper stop member positioned on the shaft outer surface; a lower stop member positioned on the shaft outer surface; a slide hammer surrounding at least a portion of the shaft and constructed and arranged to be selectively slidable along the shaft between an impacting position in which it contacts the upper stop member and a setting position in which it contacts the lower stop member; and handle means removably secured to the shaft outer surface and constructed and arranged to selectively release the anchor from the anchor insertion tool.

According to a third broad aspect of an embodiment of the present invention, there is disclosed a method for the installation and setting of an anchor in a pre-drilled hole in a surface to which the anchor is to be installed, the system comprising inserting an anchor insertion tool to an elongated shaft, the anchor insertion tool having an upper end and a lower end; operatively connecting the lower end of the anchor insertion tool to the elongated shaft; operatively securing the anchor to an internally cylindrical threaded bore defined through at least part of the upper end of the anchor insertion tool, the bore being constructed and arranged to operatively secure the anchor to the anchor insertion tool by a releasable securing means; aligning the anchor with the pre-drilled hole; moving a slide hammer positioned on the elongated shaft upwardly to impart an impacting force to an upper stop member on the elongated shaft to forcibly insert the anchor into the pre-drilled hole; pulling the slide hammer downwardly to impart an anchor setting force to a lower stop member on the elongated shaft to set the anchor; and utilizing handle means on the elongated shaft for rotating the elongated shaft so as to disengage and separate the anchor from threaded engagement with the bore of the anchor insertion tool.

According to a further broad aspect of an embodiment of the present invention, there is disclosed an anchor insertion tool for use with an anchor insertion rod for the installation and setting of an anchor, the tool comprising an upper end and a lower end integrally connected thereto, the upper end having a cross-sectional width greater than a cross-sectional width of the lower end; an internally cylindrical threaded bore defined through at least part of the upper end, wherein the bore is constructed and arranged to operatively secure the anchor to the tool by a releasable securing means; and the lower end is constructed and arranged to be operatively connected to the anchor insertion rod.

According to yet another broad aspect of an embodiment of the present invention, there is disclosed an anchor insertion tool for use with a placement tool in the installation and setting of an anchor therein, the tool having a substantially cylindrical configuration and comprising an upper end and a lower end integrally connected thereto, the upper end having a diameter greater than a diameter of the lower end; an internally cylindrical threaded bore defined through at least part of the upper end, wherein the bore is constructed and arranged to operatively secure the anchor therein during the installation and setting of the anchor; and the lower end is constructed and arranged to be operatively connected to the placement tool.

According to yet another broad aspect of an embodiment of the present invention, there is disclosed a method for the installation and setting of an anchor in a pre-drilled hole in a surface to which the anchor is to be installed, the method comprising inserting an anchor insertion tool in an elongated placement tool, the anchor insertion tool having an upper end and a lower end; operatively connecting the lower end of the anchor insertion tool to the placement tool; operatively securing the anchor to an internally cylindrical threaded bore defined through at least part of the upper end of the anchor insertion tool, wherein the bore is constructed and arranged to operatively secure the anchor to the anchor insertion tool by a releasable securing means; aligning the anchor with the pre-drilled hole; utilizing the placement tool to forcibly insert the anchor into the pre-drilled hole; pulling the placement tool downwardly to set the anchor; and rotating the placement tool so as to disengage and separate the anchor from threaded engagement with the bore of the anchor insertion tool.

An important advantage of the present invention is that it provides an improved anchor insertion rod that does away with the need to utilize wire loops and an anchoring hook to set the anchor, simplifying the anchor setting process and increasing productivity. In other words, the precise cooperation of the features of the present invention allows for the reliable, consistent and accurate setting of anchors.

A still further advantage of the present invention is that it provides an improved anchor insertion rod which can be quickly and accurately used to both insert and set an anchor, and which utilizes handles to selectively release the anchor from engagement with the anchor insertion rod and anchor insertion tool mounted thereon.

Yet another advantage of the present invention is that it provides an improved anchor insertion tool for use with an anchor insertion rod, and having an internally threaded bore defined on the top surface thereof for securing and mounting an anchor therein, and which can be constructed and arranged to accommodate varying sizes of threaded anchors therein, and which is readily adaptable for utilizing different types of anchors, according to the factors such as the physical requirements of the location. As an example, the present could be utilized for installing and setting certain anchors which are suited for use in a drop ceiling, along with other types of anchors that may be required for other locations, such as areas in close proximity to corners.

### BRIEF DESCRIPTION OF THE DRAWINGS

The embodiments of the present invention will now be described by reference to the following figures, in which identical reference numerals in different figures indicate identical elements and in which:

FIG. 1 is a perspective view of an embodiment of the anchor insertion rod of the present invention, illustrating an anchor insertion tool secured therein;

FIG. 2 is a partial cut-away view of an embodiment of the anchor insertion rod of the present invention, illustrating the handles and upper stop member;

FIG. 3 is a perspective view of an embodiment of the anchor insertion rod of the present invention, illustrating an anchor insertion tool secured therein;

FIG. 4 is a side view of an embodiment of the anchor insertion tool, illustrating a threaded anchor inserted therein;

FIG. 5 is a front view of an embodiment of the anchor insertion tool of the present invention in an upright position; and

FIG. 6 is a partial side view of an embodiment of the anchor insertion tool of the present invention, illustrating a threaded anchor inserted therein.

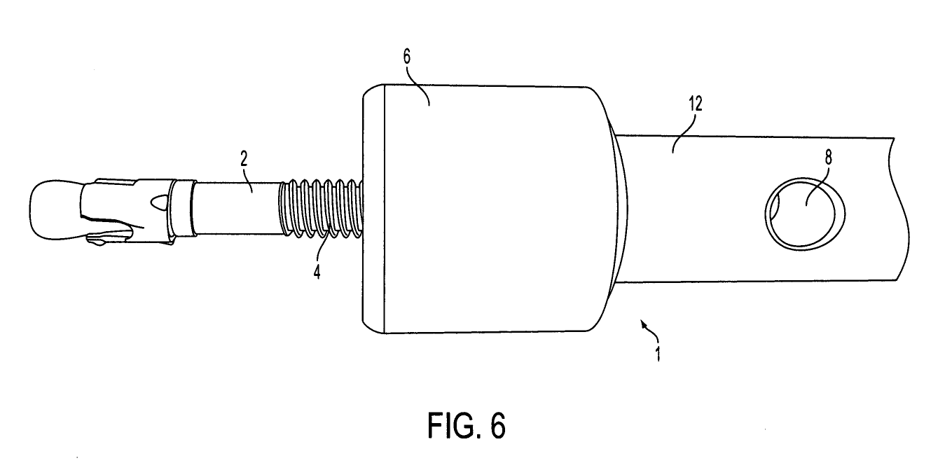

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The present invention consists of an improved anchor insertion rod for use with an anchor insertion tool in the installation and setting of anchors. Preferably, the anchor insertion tool will be mounted upon the anchor insertion rod.

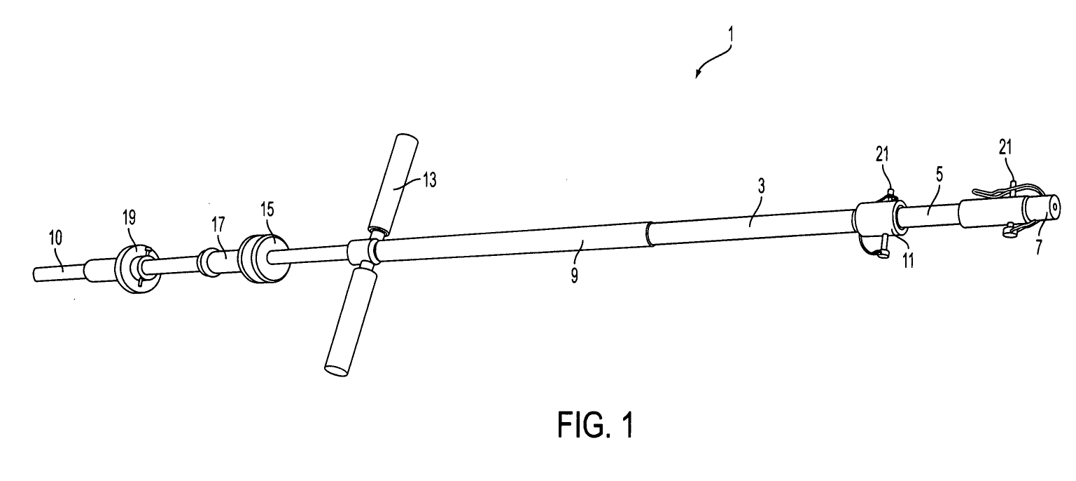

Referring to FIG. 1, there is shown an anchor insertion rod shown generally at 1 in accordance with a first exemplary embodiment of the present invention. In a preferred embodiment, as hereinafter described, the anchor insertion rod 1 is elongated, whereby a worker can utilize the anchor insertion rod 1 to insert and set an anchor (not shown) at a remote location by means of the anchor insertion tool 7 mounted thereon. It is, of course, to be understood that there are numerous variations as to the types of anchor insertion tools that could be utilized in conjunction with the present invention, which would be readily apparent to one skilled in the art.

In a preferred embodiment, the anchor insertion rod 1 will be made of a durable, machinable metal and is cylindrical in shape, though it will be readily apparent to one skilled in the art that other shapes could be utilized, such as a square or hexagonal shape, it being understood that the two portions which comprise the anchor insertion rod 1, as noted hereinafter, will have correspondingly similar shapes.

The anchor insertion rod 1 has an upper end 11 and a lower end 10, and preferably comprises an outer member 3 and an inner member 5 slidably mounted within the outer member 3. The inner member 5 also possesses a plurality of openings (not shown) defined therethrough along a length thereof, wherein, as hereinafter described, any of the openings in the inner member 5 can be aligned with a corresponding opening (not shown) in the upper end 11, whereby, once the inner member 5 has been moved within the outer member 3 to a desired length, fastening means 21 can then be inserted through each of the openings to facilitate securement of the inner member 5 to the outer member 3 at the desired position. In this manner, the inner member 5 can be extended (or retracted) within the outer member 3 to extend (or retract) a length of the anchor insertion rod 1.

Preferably, a length of the inner member 5 is of a length that is greater than that of a length of the outer member 3, though it will be understood that variations to this can be effected.

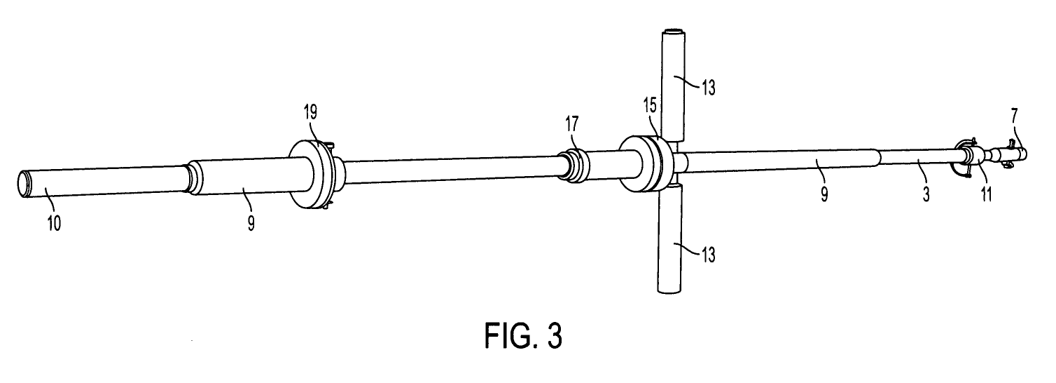

With reference to FIGS. 1 and 3, the anchor insertion rod 1 also has upper stop member 15 and lower stop member 19 positioned on an outer surface of the anchor insertion rod 1. A slide hammer 17 is provided, and surrounds a portion of the length of the outer member 3 of the anchor insertion rod 1, wherein the slide hammer is selectively slidable along the outer member 3 between the upper stop member 15 and lower stop member 19, as hereinafter described.

It will be understood that the upper stop member 15 prevents further upward movement of the slide hammer 17 along the outer member 3, and the lower stop member 19 prevents further downward movement of the slide hammer 17 along the outer member 3. It can also be seen in FIGS. 1 and 3 that the upper stop member 15 and the lower stop member 19 have a cross-sectional width that is greater than a cross-sectional width of the outer member 3.

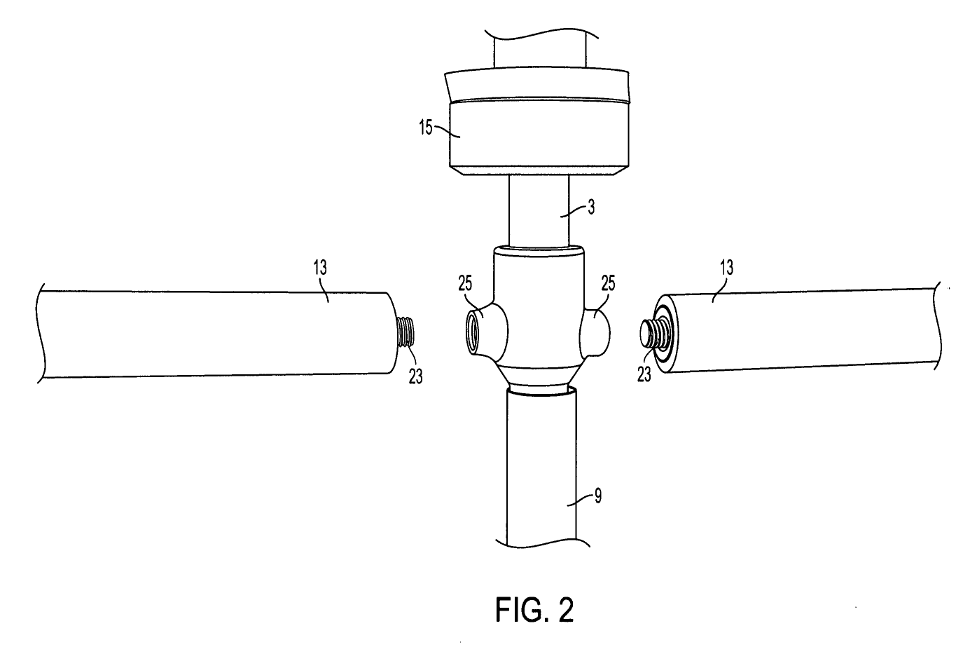

With reference to FIG. 2, it can also be seen that the anchor insertion rod 1 of the present invention further comprises handles 13, each mounted on opposed sides of the anchor insertion rod 1. In this manner the handles 13 can be utilized, once an anchor has been set, to rotate the anchor insertion rod 1 and selectively release the anchor from the anchor insertion tool 7, as hereinafter described. In a preferred embodiment, each of the handles 13 have a threaded stem 23 that is threadably secured to a corresponding bore opening 25 on the anchor insertion rod 1.

The anchor insertion rod 1 of the present invention is also provided with insulating means 9 along selected portions of a length thereof, which is designed to insulate the operator from inadvertent electrical shock. Preferably, these areas are where a user would be expected to grasp the anchor insertion rod 1.

As noted previously, the anchor insertion rod 1 of the present invention is utilized to insert and set an anchor by means of the anchor insertion tool 7 mounted thereon.

In a preferred embodiment, the anchor insertion tool 7 will be made of a durable, machinable metal and is cylindrical in shape, though it will be readily apparent to one skilled in the art that other shapes could be utilized, such as a square or hexagonal shape, or that the two portions which comprise the anchor insertion tool 7, as noted hereinafter, can have different shapes.

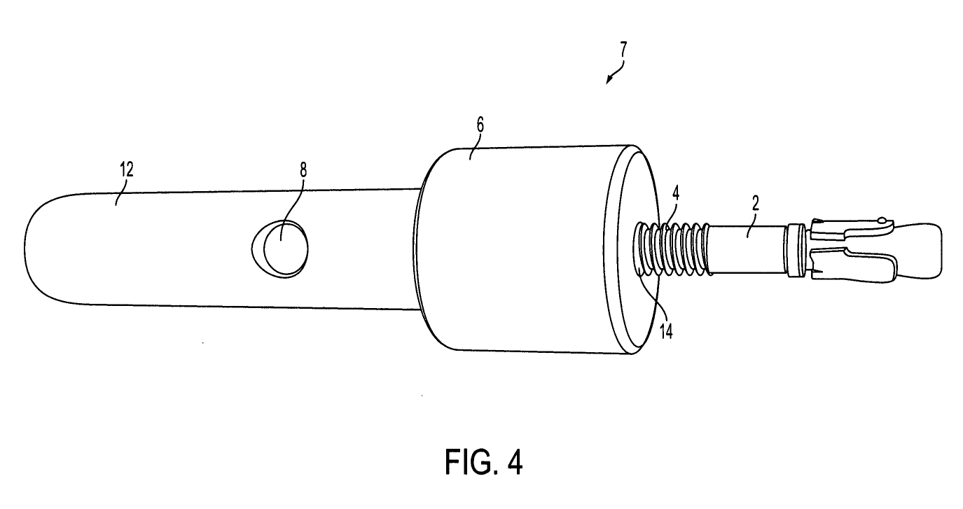

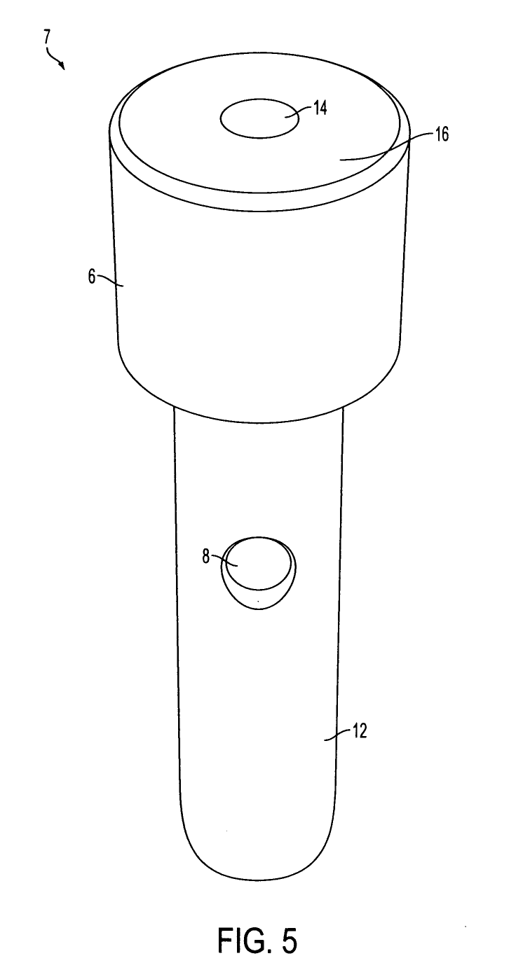

With reference to FIGS. 4 and 5, the anchor insertion tool 7 is, preferably, of a one-piece construction that comprises an upper end 6 and a lower end 12 which are integrally connected together. An internally threaded cylindrical bore 14 is defined on a top surface 16 of the upper end 6 for receiving and retaining therein an anchor 2 during the installation and setting of the anchor, for example by threads 4 of the anchor 2 engaging and cooperating with the threads (not shown) within the bore 14. In an alternative embodiment, as an example, a threaded stem (not shown) could also be threadably inserted into the bore 14, and an anchor (not shown) can be connected to the stem, for example by the anchor having a threaded bore to receive the stem.

Preferably, the bore 14 is positioned centrally on the top surface 16 of the upper end 6, so as to be coaxial with a central axis of the lower end 12. The bore 14 extends at least partly internally through the upper end 6, and is of sufficient depth to securely receive and retain the anchor 2 therein.

Of course, it will be understood that the diameter of the bore 14, as well as the depth thereof, can be varied, such variations being restrained only by the size and dimensions of the anchor insertion tool 7 on which it is located. In this manner, anchors, or threaded stems, of varying sizes and dimensions could be readily accommodated.

As shown in FIG. 4, it can be seen that the upper end 6 possesses a greater diameter than that of the lower end 12. It will be understood that, in instances where the anchor insertion tool 7 is a shape other than cylindrical, such as a square or hexagonal, the upper end 6 will preferably have a cross-sectional width greater than a cross-sectional width of the lower end 12. This is advantageous for the placement and setting of the anchor 2, as the upper end 6 provides a greater surface area for forcibly contacting the surface in which the anchor 2 is to be set, as hereinafter described.

The lower end 12 of the anchor insertion tool 7, as can be seen in FIG. 4, is of a length that is more than twice that of a length of the upper end 6, though it will be understood that variations to this can be effected. The lower end 12 also possesses an opening 8 defined therethrough, wherein, as hereinafter described, the opening 8 in the lower end 12 can be aligned with a corresponding opening (not shown) in the inner member 5 of the anchor insertion rod 1, whereby fastening means 21 can be inserted through each of the openings to facilitate securement of the anchor insertion rod 1 to the lower end 12 of the anchor insertion tool 7. In this manner, the anchor insertion tool 7 is mounted on the anchor insertion rod 1.

Preferably, the opening 8 in the lower end 12 is circular, though it will be readily understood that other types of openings could be used. Of course, any such opening in the lower end 12 would need to be compatible with the type of opening in the inner member 5 of the anchor insertion rod 1 (with or without any intermediate connectors) for mounting the anchor insertion tool 7 thereon.

In operation of the present invention, the opening 8 in the lower end 12 of the anchor insertion tool 7 is aligned with a corresponding opening (not shown) in the inner member 5 of the anchor insertion rod 1, and, as previously noted, fastening means 21 are inserted through each of the openings to facilitate securement of the anchor insertion rod 1 of the present invention to the anchor insertion tool 7. Once fastened in this manner, the rod 1 and the anchor insertion tool 7 form an elongated shaft. In this manner, a worker standing on a floor below a ceiling can reach up and insert the anchor into the ceiling without requiring the use of scaffolding or other raising means, thus providing the advantages of increased safety, convenience, efficiency and time saving.

An anchor 2 (or threaded stem portion) is inserted into the bore 14 for the installation and setting of the anchor 2. The anchor to be placed is usually intended to be positioned within a surface (such as a ceiling) wherein a pre-drilled hole (not shown) has been provided to insert the anchor 2. Such surfaces could be concrete, or other types of surfaces, as would be readily apparent to one skilled in the art.

Once the anchor is positioned within the anchor insertion tool 7, the rod 1 (and the anchor insertion tool 7 mounted thereon) is raised, and the anchor 2 is aligned so to be received within the pre-drilled hole in the surface in which the anchor is to be mounted. The user then moves the slide hammer 17 swiftly upwardly to contact the upper stop member 15, which may require one or more movements. In this manner, the top surface 16 of the upper end 6 of the anchor insertion tool 7 is forcibly contacted against the surface containing the pre-drilled hole, and forcibly inserts the anchor 2 into the pre-drilled hole, an act which is assisted by the fact that the upper end 6 (by being of a greater width than the lower end 12) provides a greater surface area for forcibly contacting the surface in which the anchor 2 is to be inserted.

Once the anchor 2 has been inserted into the pre-drilled hole, the user then moves the slide hammer 17 swiftly downwardly along the outer member 3 of the rod 1 to contact the lower stop member 19, which may also require one or more movements, so that the downward force sets the anchor in the surface. No reconfiguration is necessary to accomplish this, since the anchor 2 is threadably engaged within, and retained by, its position within the threaded bore 14.

Once the anchor is set, the handles 13 of the rod 1 placement tool can be rotated to disengage the threaded anchor 2 from threaded engagement with the anchor insertion tool 7 mounted on the rod 1 (or the connecting portion of the threaded stem), and eventually effect separation.

In this manner, the present invention can be utilized to quickly and accurately insert and set an anchor, at a height significantly above the user, and does away with the need to utilize conventional wire loops and an anchoring hook to set the anchor, simplifying the anchor setting process and increasing productivity.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

The embodiments of the invention in which an exclusive property or privilege is claimed are defined as follows:

1. A setting tool for use with an anchor insertion tool constructed and arranged to hold an anchor for installation and setting, the setting tool comprising:
an elongated shaft having an upper shaft end, a lower shaft end and a shaft outer surface, and further comprising an outer member and an inner member slidably mounted within the outer member, the shaft upper end being constructed and arranged to removably secure the anchor insertion tool by a releasable securing means, and wherein a cross-sectional width of the outer member is greater than a cross-sectional width of the inner member;
an upper stop member positioned on the shaft outer surface;
a lower stop member positioned on the shaft outer surface;
a slide hammer surrounding at least a portion of the shaft and constructed and arranged to be selectively slidable along the shaft between an impacting position in which it contacts the upper stop member and a setting position in which it contacts the lower stop member; and
handle means removably secured to the shaft outer surface and constructed and arranged to selectively release the anchor from the anchor insertion tool.

2. The setting tool of claim 1, wherein the upper stop member and the lower stop member have a cross-sectional width that is greater than a cross-sectional width of the elongated shaft.

3. The setting tool of claim 1, wherein the upper shaft end possesses at least one opening defined therethrough constructed and arranged to be aligned with a corresponding opening in the anchor insertion tool to receive fastening means inserted through each of the openings to facilitate securement of the anchor insertion tool to the upper shaft end.

4. The setting tool of claim 1, wherein the elongated shaft further comprises an outer member and an inner member slidably mounted within the outer member, the inner member having the upper shaft end thereon.

5. The setting tool of claim 1, wherein an inner surface of the outer member and an outer surface of the inner member are substantially cylindrical in shape and coaxial.

6. The setting tool of claim 5, wherein the inner member possesses a plurality of openings defined therethrough along a length thereof, each of which are constructed and arranged to be aligned with a corresponding opening in the outer member to receive fastening means inserted through the openings to facilitate securement of the inner member to the outer member at a selected extension.

7. The setting tool of claim 1, wherein the releasable securing means comprises a threaded portion proximate one end portion of the anchor.

8. The setting tool of claim 1, wherein the releaseable securing means comprises a threadable stem member having a first threaded portion constructed and arranged to be operatively connected to the anchor insertion tool, and a second portion constructed and arranged to be operatively connected to one end portion of the anchor.

9. The setting tool of claim 1, further comprising insulating means surrounding at least a portion of the elongated shaft and the handle means for insulating an operator from inadvertent electrical shock.

10. The setting tool of claim 1, wherein the handle means further comprises a first and a second handle each removably secured on opposed sides of the elongated shaft.

11. The setting tool of claim 1, wherein the handle means can be threadably secured to the elongated shaft.

12. The setting tool of claim 1, wherein a length of the inner member is greater than a length of the outer member.

13. A setting tool for use with an anchor insertion tool constructed and arranged to hold an anchor for installation and setting, the setting tool comprising:
an elongated shaft having an upper shaft end and a lower shaft end and a shaft outer surface, the shaft upper end being constructed and arranged to removably secure the anchor insertion tool by a releasable securing means;
an upper stop member positioned on the shaft outer surface;
a lower stop member positioned on the shaft outer surface;
a slide hammer surrounding at least a portion of the shaft and constructed and arranged to be selectively slidable along the shaft between an impacting position in which it contacts the upper stop member and a setting position in which it contacts the lower stop member; and
handle means removably secured to the shaft outer surface and constructed and arranged to selectively release the anchor from the anchor insertion tool.

14. The setting tool of claim 13, wherein the upper stop member and the lower stop member are substantially cylindrical in shape.

15. A method for the installation and setting of an anchor in a pre-drilled hole in a surface to which the anchor is to be installed, the method comprising:
inserting an anchor insertion tool in an elongated placement tool, the anchor insertion tool having an upper end and a lower end;
operatively connecting the lower end of the anchor insertion tool to the placement tool;
operatively securing the anchor to an internally cylindrical threaded bore defined through at least part of the upper end of the anchor insertion tool, wherein the bore is constructed and arranged to operatively secure the anchor to the anchor insertion tool by a releasable securing means;
aligning the anchor with the pre-drilled hole;
utilizing the placement tool to forcibly insert the anchor into the pre-drilled hole;
pulling the placement tool downwardly to set the anchor; and
rotating the placement tool so as to disengage and separate the anchor from threaded engagement with the bore of the anchor insertion tool.
